(19) United States
(12) Patent Application Publication
(10) Pub. No.: US 2024/0166015 A1
(43) Pub. Date: May 23, 2024

(54) SYSTEM FOR ELECTRICALLY HEATING VEHICLE WINDSHIELD

(71) Applicant: DENSO CORPORATION, Kariya-city (JP)

(72) Inventors: Jonathan NOAH-NAVARRO, Royal Oak, MI (US); Bruce BARNARD, Novi, MI (US); Chris PAQUETTE, Ferndale, MI (US); Michael BIMA, Milford, MI (US); Dwayne TAYLOR, Livonia, MI (US); James LINK, West Bloomfield, MI (US); Christopher RAINEY, Livonia, MI (US); David KORENCHUK, Royal Oak, MI (US); Mika GOCHO, Ann Arbor, MI (US); George HADLEY, Plymouth, MI (US); Koji OTA, Kariya-city (JP)

(21) Appl. No.: 18/389,449

(22) Filed: Nov. 14, 2023

Related U.S. Application Data
(60) Provisional application No. 63/426,519, filed on Nov. 18, 2022.
(60) Provisional application No. 63/426,529, filed on Nov. 18, 2022.

(51) Int. Cl. B60H 1/00

(52) U.S. Cl. CPC B60H 1/00271; B60H 1/00507; B60H 1/00742; B60H 1/00764; B60H 1/00785; B60H 2001/003

(57) ABSTRACT

A system for electrically heating glass configured for installation on a vehicle. The system includes: a transparent metallic layer configured to be mounted to the glass, conduct electrical current, and increase in temperature to heat the glass in response to electrical current running across the transparent metallic layer; a glass temperature sensor configured to sense a glass temperature of the glass; a humidity sensor configured to sense humidity of at least one of cabin humidity inside the vehicle and exterior humidity outside of the vehicle; a cabin temperature sensor configured to sense cabin temperature of the vehicle; an exterior temperature sensor configured to sense exterior temperature outside of the vehicle; and a control module.

### CROSS-REFERENCE TO RELATED APPLICATIONS

This application claims the benefit of U.S. Provisional Application Nos. 63/426,519 and 63/426,529 (both filed on Nov. 18, 2022), the entire disclosures of which are incorporated herein by reference.

### FIELD

The present disclosure relates to systems for electrically heating a vehicle windshield and other glass surfaces.

### BACKGROUND

This section provides background information related to the present disclosure, which is not necessarily prior art.

Traditionally, vehicle windshields are defrosted, deiced, and/or defogged by directing a flow of hot air from vents of an HVAC system of the vehicle to the windshield to heat the glass. Ice or frost formed on the windshield is then melted by the heat from the glass of the windshield as it is heated by the hot air flow from the vents of the HVAC system. Similarly, any fog on the windshield dissipates as the glass is warmed to a temperature above the current dew point of the vehicle environment. Defrosting, deicing, and/or defogging the vehicle windshield using hot air from the HVAC system, however, can take a large amount of time and can consume a large amount of energy. For example, defrosting a vehicle windshield using hot air from the HVAC system can take 20 to 30 minutes and can consume 5.2 kilowatt-hours (kWh) of energy. As such, a quicker and more energy efficient method and system are needed.

### SUMMARY

This section provides a general summary of the disclosure, and is not a comprehensive disclosure of its full scope or all of its features.

The present disclosure includes a system for electrically heating glass configured for installation on a vehicle. The system includes: a transparent metallic layer configured to be mounted to the glass, conduct electrical current, and increase in temperature to heat the glass in response to electrical current running across the transparent metallic layer; a glass temperature sensor configured to sense a glass temperature of the glass; a humidity sensor configured to sense humidity of at least one of cabin humidity inside the vehicle and exterior humidity outside of the vehicle; a cabin temperature sensor configured to sense cabin temperature of the vehicle; an exterior temperature sensor configured to sense exterior temperature outside of the vehicle; and a control module. The control module is configured to: receive inputs from at least one of the glass temperature sensor, the humidity sensor, the cabin temperature sensor, the exterior temperature sensor, an occupant detection system, and a vehicle speed sensor; determine a remedial action based on at least one of the received inputs from the at least one of the glass temperature sensor, the humidity sensor, the cabin temperature sensor, the exterior temperature sensor, the occupant detection system, and the vehicle speed sensor; and control electrical current to the transparent metallic layer based on at least one of the inputs and the remedial action.

The present disclosure further includes a system for electrically heating glass configured for installation on a vehicle. The system includes: a transparent metallic layer configured to be mounted adjacent to the glass; a power supply; and a control module. The control module is configured to: communicate with a glass temperature sensor configured to sense a temperature of the glass; communicate with at least one of an indoor temperature sensor configured to sense a temperature inside the vehicle, and an outdoor temperature sensor configured to sense a temperature outside the vehicle; receive the glass temperature from the glass temperature sensor; receive at least one of the temperature inside the vehicle from the indoor temperature sensor, the temperature outside the vehicle from the outdoor temperature sensor, and a humidity value of humidity inside or outside of the vehicle; calculate a dew point based on at least one of the temperature inside the vehicle, the temperature outside the vehicle, and the humidity value; and periodically apply voltage from the power supply to the transparent metallic layer to heat the glass based on the glass temperature and the dew point.

The present disclosure also includes a system for electrically heating glass configured for installation on a vehicle. The system includes: a transparent metallic layer configured to be mounted to the glass, be selectively connected to a battery, conduct electrical current, and increase in temperature to heat the glass in response to electrical current running across the transparent metallic layer; a vehicle heating system configured to selectively heat the battery and a cabin of the vehicle; and a control module configured to: selectively connect the transparent metallic layer to the battery; during a first time period, activate the vehicle heating system to heat the battery without heating the cabin, and without connecting the transparent metallic layer to the battery; during a second time period after the first time period, deactivate the heating system and connect the transparent metallic layer to the battery to heat the transparent metallic layer and the glass; and during a third time period after the second time period, disconnect the transparent metallic layer from the battery, and activate the heating system to heat the cabin without heating the battery.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary system in accordance with the present disclosure for electrically heating a windshield or other glass surface of a vehicle;

FIG. 2 illustrates an exemplary vehicle including the system of the present disclosure;

FIG. 3 illustrates layers of an exemplary windshield including a transparent metallic layer in accordance with the present disclosure;

FIG. 4 illustrates various control modules and systems of the present disclosure;

FIG. 5 illustrates the system of the present disclosure in cooperation with exemplary refrigeration/heating circuits of the vehicle; and

FIG. 6 illustrates an exemplary control algorithm in accordance with the present disclosure configured to defog (and prevent fogging of) a windshield and other glass surfaces of a vehicle.

Corresponding reference numerals indicate corresponding parts throughout the several views of the drawings.

### DETAILED DESCRIPTION

Example embodiments will now be described more fully with reference to the accompanying drawings.

The present disclosure includes systems and methods for defrosting, deicing, and/or defogging a vehicle windshield and/or other glass surfaces (e.g., side windows, rear window, glass roof, etc.) by running electrical current through, or otherwise across, the windshield and/or other glass surfaces. Any suitable system for applying electrical current may be used, such as, but not limited to, a pulse-electro thermal deicing (PETD) heater system. The present disclosure applies to heating vehicle glass, as well as non-vehicular glass as well. The present disclosure is thus not limited to automotive applications. The present disclosure applies to any glass surfaces in need of defogging, deicing, defrosting, etc.

The present disclosure includes systems and methods configured to quickly and efficiently defrost, deice, and/or defog a vehicle windshield by heating the windshield through the application of a voltage to a transparent metallic layer of the windshield. The heat may be generated by a PETD heater system or any other suitable system configured to direct electrical current through or otherwise across a vehicle windshield and/or any other glass surfaces. Heat generated by the electrical current running through the transparent metallic layer of the windshield heats the windshield to defrost, deice, and/or defog the vehicle windshield. For example, the PETD heater system can quickly heat the windshield and melt a layer of ice formed on the windshield causing the remaining ice on the windshield to be separated from the windshield by a layer of water. Once the layer of water has formed between the windshield and the remaining ice on the windshield, the windshield wipers of the vehicle can be activated to brush the remaining ice off of the windshield. In one embodiment, for example, defrosting a windshield using a PETD heater system in accordance with the present disclosure can take less than one minute and can consume 0.12 kWh of energy. As compared with the 20-30 minutes and 5.2 kWh required for a traditional system using hot air flow from an HVAC system, the PETD heater system can provide significant time and energy savings.

PETD heater systems and related concepts are shown and described in the following patents, which are incorporated herein by reference in their entirety: U.S. Pat. No. 6,870,139, titled “Systems and methods for modifying an ice-to-object interface”; U.S. Pat. No. 8,921,739, titled “Systems and methods for windshield deicing”; U.S. Pat. No. 10,473,381 “High-frequency self-defrosting evaporator coil”; U.S. Pat. No. 11,229,091, titled “Continuous resistance and proximity checking for high power deicing and defogging systems.”

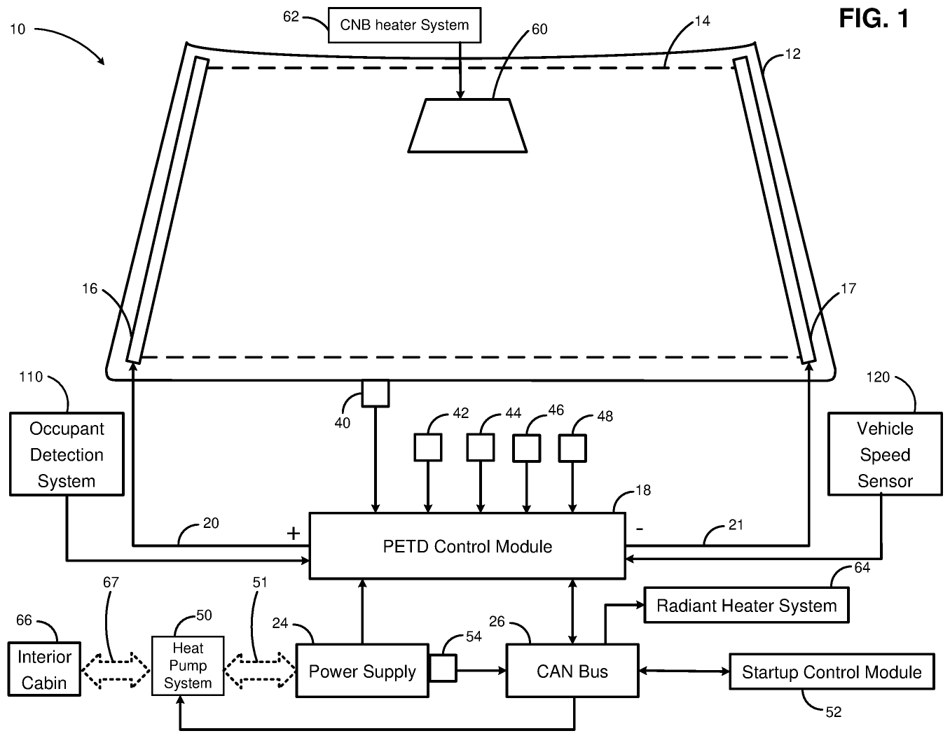

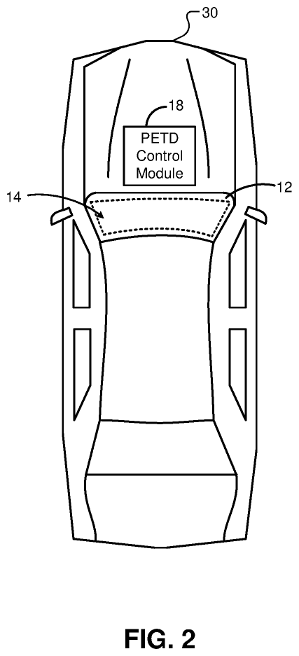

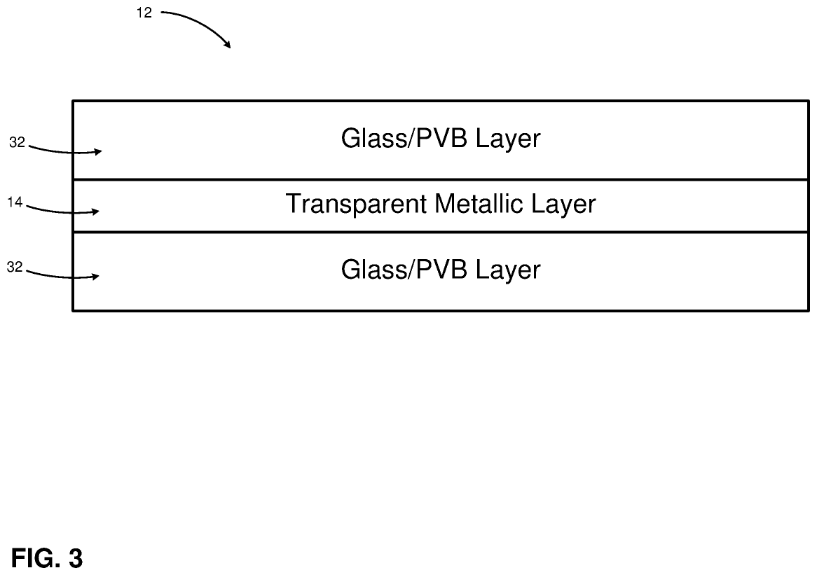

With reference to FIGS. 1-3, an exemplary PETD heater system 10 for a windshield 12 of a vehicle 30 is shown. The PETD heater system 10 includes a transparent metallic layer 14, also referred to as a transparent metallic sheet, embedded within the windshield 12. As shown in FIG. 3, the transparent metallic layer 14 can be sandwiched between one or more layers 32 of glass and/or polyvinyl butyral (PVB) shatter-resistant plastic. While the example of FIG. 3 includes a single transparent metallic layer 14 between layers 32 of glass or PVB, other configurations using additional transparent metallic layers 14 and/or additional glass or PVB layers can be used. The transparent metallic layer 14 in the windshield 12 can also be used to reflect infrared solar energy away from the interior of the vehicle 30.

The transparent metallic layer 14 is connected on opposite sides to bus bars 16, 17. While FIG. 1 shows the bus bars 16, 17 located on the left and right sides of the transparent metallic layer 14, the bus bars 16, 17 can alternatively be located on the top and bottom sides of the transparent metallic layer 14, or at other suitable locations. The bus bars 16, 17 are connected to a PETD control module 18 via wires 20, 21. The PETD control module 18 is connected to an electrical power supply 24 and a communication bus 26, such as a Controller Area Network (CAN) bus. The PETD control module 18 can, for example, be an electronic control unit (ECU) and can communicate with other ECUs and other devices or components of the vehicle 30 using the communication bus 26. The PETD control module 18 can be, and/or can include, a controller, a microcontroller, a microcomputer, or other computing device with a processor, memory, and/or other hardware and circuitry configured to control the PETD heater system 10 in accordance with the present disclosure.

The electrical power supply 24 can be one or more batteries of the vehicle 30. For example, in an electric vehicle the electrical power supply 24 can be a 400 to 900-volt battery. In a hybrid vehicle, the electrical power supply 24 can be a 36-volt battery. In an internal combustion engine vehicle, the electrical power supply 24 can be a 12-volt battery. While specific examples for batteries are provided, a battery of any suitable voltage can be used.

When the PETD heater system 10 is activated to perform defrosting, deicing, and/or defogging of the vehicle windshield 12, the PETD control module 18 applies a voltage to the bus bars 16, 17 by connecting the wires 20, 21 to the power supply 24. As shown in FIG. 1, wire 20 and bus bar 16 are shown as being on the positive terminal side and wire 21 and bus bar 17 are shown on the negative terminal side creating a voltage differential between the bus bars 16, 17 and allowing current to flow from the power supply 24 to the bus bars 16, 17 and across the transparent metallic layer 14. The control module 18 includes one or more switches, as necessary, to control and apply voltage to the wires 20, 21 and bus bars 16, 17. The voltage differential causes electrical current to flow across the transparent metallic layer 14, which heats the transparent metallic layer 14 and, in turn, heats the other layers of the windshield 12, such as the layers 32 of glass/PVB. The voltage applied to the bus bars 16, 17 and the transparent metallic layer 14 can be pulsed using a duty cycle or can be applied continuously until the PETD heater system 10 is turned off.

In this way, the PETD control module 18 controls the voltage applied to the bus bars 16, 17 and the flow of electrical current across the transparent metallic layer 14 to heat the windshield 12. As noted above, the heat from the windshield 12 can melt a thin layer of ice formed on the windshield 12 creating a thin layer of water between the windshield 12 and the remaining ice on the windshield 12. At that point, the windshield wipers of the vehicle 30 can be activated to brush the remaining ice off of the windshield 12. Similarly, the heat from the windshield 12 can also cause any fog or condensation formed on the windshield 12 to dissipate once the windshield 12 has been heated to above the current dew point of the environment of the vehicle 30.

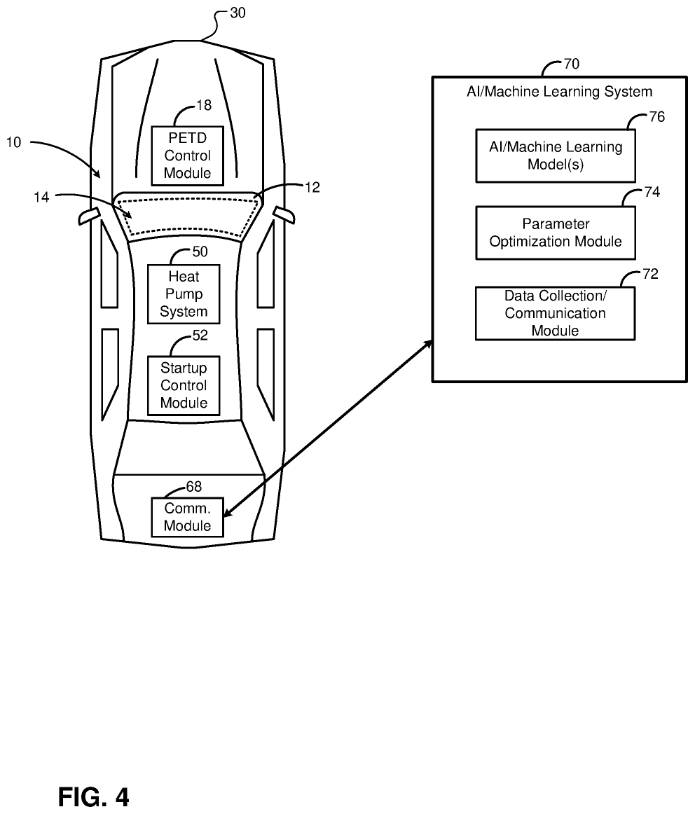

With reference to FIGS. 1 and 4, for example, in an embodiment the vehicle 30 may be equipped with a heat pump system 50, in addition to the PETD heater system 10. The heat pump system 50, for example, can include traditional components, such as a compressor, condenser, expansion valve, and evaporator, to transfer heat from outside to inside of the vehicle 30 to heat an interior of the vehicle 30. Additionally, and more specifically, the heat pump system 50 can be configured to provide heat to the power supply 24, such as a battery, of the vehicle 30, as shown by double arrow 51. Additionally, the heat pump system 50 can be configured to provide heat to the interior cabin 66 of the vehicle, as shown by double arrow 67.

The vehicle 30 can include a startup control module 52 in communication with the PETD control module 18 and the heat pump system 50 via the communication bus 26. The startup control module 52 is configured to control activation and operation sequence of the PETD heater system 10 and the heat pump system 50 upon startup. A battery temperature sensor 54 can be configured to sense a temperature of the power supply 24, such as a battery, of the vehicle 30 and can communicate the battery temperature to the startup control module 52 via the communication bus 26.

In addition, environmental sensors 40, 42, 44, 46 are shown and are in communication with the PETD control module 18 to provide environmental parameter data to the PETD control module 18. For example, the PETD heater system 10 can include a windshield temperature sensor 40 that senses a temperature of the windshield 12 and communicates data indicating the temperature of the windshield to the PETD control module 18. The PETD heater system 10 can also include an ambient outdoor temperature sensor 42 that senses an ambient outdoor temperature of the environment surrounding the vehicle 30 and communicates data indicating the ambient outdoor temperature to the PETD control module 18. The PETD heater system 10 can also include a humidity sensor 44 that senses a humidity of the air in the environment surrounding the vehicle 30 and/or the air within the vehicle and communicates data indicating the humidity to the PETD control module 18. The PETD heater system 10 can also include an indoor temperature sensor 42 that senses an indoor temperature within the vehicle 30 and communicates data indicating the indoor temperature to the PETD control module 18.

The humidity sensor 44, for example, can be an optical sensor located on the back of a rearview mirror of the vehicle 30 and optically senses condensation and fog formed on the windshield 12 of the vehicle 30. For example, the optical sensor can sense an amount of ambient light that is able to pass through the windshield 12 and can determine a humidity based on the amount of light. As increased condensation and fogging forms on the windshield, less light is able to pass though. The humidity sensor 44 can assign a humidity data value based on the amount of light that is able to pass through the windshield. Additionally or alternatively, the system 10 is configured to receive current outside humidity and/or dew point readings from any suitable third party weather reporting agency, such as any suitable commercial, government, or private weather reporting agency. For example, the system 10 may include any suitable receiver 48 configured to receive weather reports including humidity and/or dew point readings. The receiver may be configured to receive any suitable signals, such as, but not limited to, cellular, AM/FM, satellite, etc. While the sensors 40, 42, 44, 46, and receiver 48 are shown as being in direct communication with the PETD control module 18, the sensors 40, 42, 44, 46, and receiver 48 can alternatively communicate with the PETD control module 18, or other system components or modules, through the communication bus 26.

For efficient operation, the battery of the vehicle 30 must generally be above a predetermined temperature threshold. As such, the startup control module 52 can prioritize heating of the battery as a first priority before activating other components and systems, such as the PETD heater system 10. For example, the startup control module 52 can receive the battery temperature from battery temperature sensor 54 and can activate the heat pump system 50 to heat the battery for a predetermined time period or until the temperature of the battery rises above a predetermined temperature.

Once the battery of the vehicle 30 has reached the predetermined temperature threshold, the startup control module 52 can then prioritize the defrosting of the windshield 12. As such, the startup control module 52 can deactivate the heat pump system 50 and can activate the PETD heater system 10 to heat and defrost the windshield 12. For example, the startup control module 52 can instruct the PETD control module 18, via communication through the communication bus 26, to apply voltage to the transparent metallic layer 14 to heat the windshield 12 for a predetermined time period or until the windshield 12 reaches a predetermined temperature, as sensed by the windshield temperature sensor 40. Once the windshield 12 has been heated and defrosted by the PETD heater system 10, the startup control module 52 can then deactivate the PETD heater system 10 and reactivate the heat pump system 50 to provide heat to an interior of the vehicle 30.

As shown in FIG. 1, the windshield 12 may include a portion that is not covered by the transparent metallic layer 14. For example, some sensors, such as a LIDAR sensor and/or a camera, may not be able to properly sense conditions outside of the windshield 12 through the transparent metallic layer 14. As such, the transparent metallic layer 14 may include a window 60 that does not include the transparent metallic layer 14. The sensors, such as any LIDAR sensors and/or cameras, may be positioned behind the window 60. For example, such sensors could be mounted to a rearview mirror attached to the windshield 12.

Since the portion of the windshield 12 corresponding to the window 60 is not heated by the PETD heater system 10, the vehicle 30 may include an additional heater system to heat the portion of the windshield 12 corresponding to the window 60. For example, a carbon nanotube based (CNB) heater system 62, also referred to as a carbon nanotube (CNT) heater, can be used to heat the portion of the windshield 12 corresponding to the window 60. The CNB heater can be, for example, a CNB heater system available from Canatu. The CNB heater system 62 may include a film or sheet layer of carbon nanotubes positioned and overlayed on the windshield 12 at a position corresponding to the window 60. The carbon nanotubes of the CNB heater system 62 can then be heated by a heat source to provide localized heating of the portion of the windshield corresponding to the window 60. The CNB heater system 62 may be in communication with the startup control module 52 via the communication bus 26.

The vehicle 30 may also include a radiant heater system 64 configured to provide radiant heat to occupants of the vehicle 30. For example, the radiant heater system 64 can be located in the footwells or in the dash of the vehicle to provide radiant heat to the feet, legs, torso, or face of one or more occupants of the vehicle 30. The radiant heater system 64 can be in communication with the startup control module 52 via the communication bus 26.

The startup control module 52 can be configured to control the PETD heater system 10, the heat pump system 50, the CNB heater system 62, and the radiant heater system 64 on startup according to the following Table 1:

TABLE 1

| | | Heat Pump | Heat Pump | | |
|---|---|---|---|---|---|
| | PETD | System | System | CNB | Radiant |
| | Heater | (50) for | (50) for | Heater | Heater |
| Time | System | Battery | Whole | System | System |
| Period | (10) | Only | Cabin | (62) | (64) |
| First Time | OFF | ON | OFF | OFF | OFF |
| Period | | | | | |
| Second | ON | OFF | OFF | ON | ON |
| Time | | | | | |
| Period | | | | | |
| Third Time | OFF | OFF | ON | ON/ | ON/ |
| Period | | | | OFF | OFF |

Using the startup control logic shown in Table 1, the startup control module 52 can operate for a first time period using the heat pump system 50 to only heat the power supply 24, i.e., the vehicle battery. As shown in Table 1, during the first time period, the PETD heater system 10, the CNB heater system 62 and the radiant heater system 64 are off and the heat pump system 50 is on only for heating the battery, but not for heating the whole interior cabin 66 of the vehicle 30. Once the temperature of the battery reaches a predetermined threshold, the startup control module 52 proceeds to the second time period. In the second time period, the PETD heater system 10, the CNB heater system 62, and the radiant heater system 64 are all turned on and the heat pump system 50 is turned off. The second time period can be a sufficient time to defrost the windshield 12. For example, the second time period can be one minute. After the second time period, the startup control module 52 proceeds to the third time period. In the third time period, the PETD heater system 10 and the heat pump system 50 for the battery are turned off. The heat pump system 50 for heating the interior cabin 66 of the vehicle 30, however, is turned on. Further, in the third time period the CNB heater system 62 and the radiant heater system 64 can be turned on or off, as needed, depending on the heating needs of the vehicle 30 and/or users of the vehicle 30.

Alternatively, in the event heating of the battery of the vehicle 30 is not initially needed, the initial heating of the battery with the heat pump system 50 can be omitted. In this configuration, the startup control module 52 can control the system components on startup based on the control logic shown in Table 2:

TABLE 1

| | | Heat Pump | Heat Pump | | |
|---|---|---|---|---|---|
| | PETD | System | System | CNB | Radiant |
| | Heater | (50) for | (50) for | Heater | Heater |
| Time | System | Battery | Whole | System | System |
| Period | (10) | Only | Cabin | (62) | (64) |
| First Time | ON | OFF | OFF | ON | ON |
| Period | | | | | |
| Second | OFF | OFF | ON | ON/OFF | ON/OFF |
| Time | | | | | |
| Period | | | | | |

Using the startup control logic shown in Table 2, the startup control module 52 can operate for a first time period by turning on the PETD heater system 10, the CNB heater system 62, and the radiant heater system 64 and turning off the heat pump system 50. The first time period can be a sufficient time to defrost the windshield 12. For example, the first time period can be one minute. After the first time period, the startup control module 52 proceeds to the second time period. In the second time period, the PETD heater system 10 and the heat pump system 50 for the battery are turned off. The heat pump system 50 for heating the interior cabin 66 of the vehicle 30, however, is turned on. Further, in the second time period the CNB heater system 62 and the radiant heater system 64 can be turned on or off, as needed, depending on the heating needs of the vehicle 30 and/or users of the vehicle 30.

The startup control logic can also be used to determine when to activate wipers of the vehicle 30 to brush off ice from the windshield 12 once the PETD heater system 10 has melted a layer of ice to form a layer of water between the windshield 12 and the remaining ice. For example, the startup control logic can include activation of the wipers once the PETD heater system 10 has been deactivated or at the end of activation of the PETD heater system 10. Additionally or alternatively, the PETD control module 18 can monitor system conditions, including the temperature of the windshield 12, and determine when the layer of water has sufficiently formed and then automatically activate the windshield wipers at that time. Additionally or alternatively, the system can include a camera or image sensor that monitors a color of the ice and frost on the windshield 12. Once the color of the ice and frost has sufficiently changed, the PETD control module 18 can determine that the layer of water has formed and then proceed with activating the windshield wipers. Additionally or alternatively, the startup control logic can prevent the windshield wipers from being activated during the time period when the PETD heater system 10 is activated and/or until a predetermined initial time period has elapsed after activation of the PETD heater system 10 and/or while the vehicle 30 is stationary.

With reference to FIGS. 1 and 4, the vehicle 30 can include a communication module 68 that communicates data from the vehicle 30 to other systems outside of the vehicle 30. For example, the communication module 68 of the vehicle can be in communication with a cloud-based AI/machine learning system 70. The AI/machine learning system 70 includes a data collection/communication module 72 configured to communicate with the communication module 68 of the vehicle 30.

In particular, the data collection/communication module 72 can collect and receive all manner of operating data and setpoints from the vehicle 30 related to operation of the vehicle, such as the speed of the vehicle 30 and GPS location of the vehicle 30. The GPS location of the vehicle 30 can be used to determine a position of the vehicle 30 relative to sea level. In this way, the various control strategies and parameters can be updated and modified in real-time to account for the location of the vehicle 30. In this way, different control strategies and parameters can be used depending on whether the vehicle 30 is at or near sea level or at a higher elevation/altitude, such as in a mountainous region. The data collection/communication module 72 can also receive operational data related to the setpoints and various temperatures, pressures, etc., related to operation of the PETD heater system 10, the heat pump system 50, the CNB heater system 62, the radiant heater system 64, including the windshield temperature data, outdoor ambient temperature data, indoor ambient temperature data, humidity data, etc. The data collection/communication module 72 can also receive data related to the power supply 24, such as the battery of the vehicle, as well as data related to power consumption for operation of the various vehicle systems. The data collection/communication module 72 can also receive data related occupancy of the vehicle, such as data from occupancy sensors, data from infrared (IR) sensors, and/or data from cameras within the vehicle 30.

All of the collected data from the vehicle can be utilized by a parameter optimization module 74 of the AI/machine learning system 70 to calculate and determine optimized operational parameters that are then communicated back to the vehicle 30 and used to operate the various vehicle systems, including the PETD heater system 10, the heat pump system 50, the CNB heater system 62, the radiant heater system 64, etc. Additionally, the optimized operational parameters can be utilized by the startup control module 52 to determine optimized setpoints and time periods for the startup control algorithm to control activation and deactivation of the various vehicle systems. For example, the parameter optimization module 74 can input the collected data from the vehicle 30 to one or more AI/machine learning model(s) 76 stored in the cloud-based AI/machine learning system 70 to determine optimized parameters and setpoints for the various vehicle systems of the vehicle 30. The optimized parameters and setpoints can then be communicated by the data collection/communication module 72 back to the communication module 68 of the vehicle in real time. The communication module 68 can then communicate the optimized parameters and setpoints to the various vehicle systems and ECUs to improve operation and efficiency of the various vehicle systems.

In this way, the control logic of the various vehicle systems, and the setpoint times and thresholds, setpoint temperatures and thresholds, etc., can be optimized based on vehicle system data that is monitored, collected, and processed by the cloud-based AI/machine learning system 70 in real time. The cloud-based AI/machine learning system 70 can also provide real-time control of the various vehicle systems. The AI/machine learning system 70 can also include control logic for filtering and determining which types of data from one or more vehicles 30 or vehicle systems is authorized for inclusion and incorporation into the AI/machine learning model(s) 76. In addition to real-time adjustments, the AI/machine learning system 70 can collect data from multiple vehicles 30 over time and determine optimization parameters and strategies that are then sent out as updates to multiple vehicles 30.

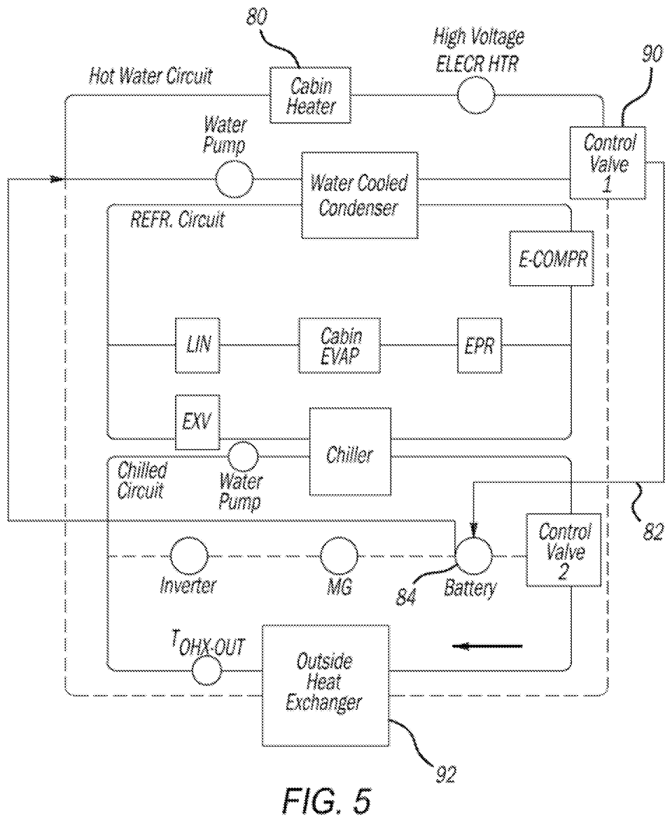

In other features, because the heat pump system 50 and/or HVAC system is not needed to defrost the windshield 12 of the vehicle, heat from the heat pump system 50 and/or the HVAC system can be diverted on startup to heat the battery of the vehicle 30. Additionally or alternatively, on startup all heat from the heat pump system 50 and/or HVAC system can initially be diverted to heat the battery of the vehicle 30 prior to heating the cabin of the vehicle 30. As shown in FIG. 5, the vehicle 30 can include a number of refrigeration/heating circuits, such as a hot water circuit, a refrigeration circuit, and a chilled water circuit. The hot water circuit can be used to operate a cabin heater 80 that provides heat to an interior cabin of the vehicle 30. As shown in FIG. 5, the heat pump system can include a diverter path 82 that diverts hot water from the hot water circuit to the battery 84 of the vehicle 30 to heat the battery. For example, on startup the control valve can control the flow of hot water so that hot water does not flow to the cabin heater 80 and instead flows to the battery 84 via the diverter path 82. Once startup is complete and the battery 84 is sufficiently heated, the diverter path 82 can be closed and the control valve 90 can allow hot water in the hot water circuit to again flow to the cabin heater 80 to heat an interior cabin of the vehicle 30. Additionally or alternatively, a second diverter path can also be used to direct hot water from the hot water circuit to the outdoor heat exchanger. In this way, since the PETD heater system 10 can be used to defrost the windshield 12 of the vehicle 30, hot water from the hot water circuit of the heat pump system 50 can be diverted to heat the battery 84 and/or the outdoor heat exchanger 92 of the heat pump system 50. In this way, optimal system temperatures can be achieved rapidly. Additionally, the heat pump system 50 can be resized to account for the reduced heating capacity needed at startup since the heat pump system 50 is not needed to defrost the windshield 12.

In other features, the PETD heater system 10 can be configured to operate at two different voltages and can select the amount of voltage to apply to the transparent metallic layer 14. For example, the PETD heater system 10 can use pulse-width modulation and a duty cycle to control the effective voltage applied to the transparent metallic layer 14. For example, the normal/high voltage of the power supply 24 can be applied to the transparent metallic layer periodically using pulse-width modulation and a duty cycle so that the effective voltage experienced by and applied to the transparent metallic layer is effectively a lower voltage than the normal/high voltage of the power supply 24. For further example, the normal/high voltage of the power supply 24 can be applied without pulse-width modulation when the PETD heater system 10 is defrosting the windshield 12. Additionally, the PETD control module 18 can use pulse-width modulation and a duty cycle to apply a reduced effective voltage to the transparent metallic layer when the PETD heater system 10 is used for defogging the windshield 12.

As illustrated in FIG. 1, the PETD control module 18 is in cooperation with an occupant detection system 110 and a vehicle speed sensor 120 of the vehicle 30. The occupant detection system 110 includes any suitable sensors configured to identify whether occupants are present within the vehicle 30. For example, the occupant detection system 110 may include any suitable camera sensors directed towards the seats of the vehicle 30, and/or pressure sensors within the seats of the vehicle 30. The vehicle speed sensor 120 is configured to sense whether the vehicle 30 is moving, and the speed of the vehicle 30. Any suitable speed sensor may be included.

The PETD control module 18 is configured to vary the voltage of the PETD heater system 10 based on whether the vehicle 30 is moving and whether the vehicle 30 is occupied. For example, the normal/high voltage of the power supply 24 can be applied when, based on inputs from the occupant detection system 110 and the vehicle speed sensor 120, the vehicle 30 is unoccupied or the vehicle 30 or stopped. Otherwise, the reduced effective voltage is applied. As a result, occupants are protected in the event of an accident, and in the unlikely event that a collision detection system and a high-voltage cut-off system become disabled.

In certain hot and humid environments, such as in the state of Florida in the United States, the dew point may be relatively high, such as 78° F. Overnight, the ambient temperature may drop and then in the morning the ambient temperature may quickly rise again, for example to 85° F., while the humidity may be relatively high, such as 95% humidity. In this situation, when a user operates the vehicle, the windshield may remain at the colder overnight temperature forming significant condensation and fogging. To clear the fogging and condensation caused by this scenario, traditionally a user would be required to run the heat and defrost to heat the windshield to clear the fog. Since the ambient temperature is relatively high, such as 85° F., the user may not want to run the heater with such a high ambient temperature. In this type of scenario, the PETD heater system 10 can be used to heat the windshield 12 without having to operate a defrost function of an HVAC system of the vehicle 30. In addition, the user can heat the windshield using the PETD heater system 10 defog the windshield while operating an air conditioning function of the HVAC system of the vehicle 30 to cool an interior of the vehicle 30 to a comfortable temperature for the user. For further example, the PETD heater system 10 can monitor the ambient outdoor temperature sensed by the outdoor temperature sensor 42 and the humidity sensed by the humidity sensor 44 (and/or the external humidity and dew point as reported by any suitable weather reporting service transmitted to the vehicle and received by the receiver 48), calculate the current dew point, and operate the PETD heater system 10 to heat the windshield to a temperature above the dew point. Simultaneously, the HVAC system of the vehicle 30 can be operated to cool the temperature to a cooling setpoint determined by the HVAC system or selected by the user. In other embodiments, a PETD heater system 10 can additionally be used on interior windows of a building to clear fog and condensation of the windows of the building without having to heat the room of the building.

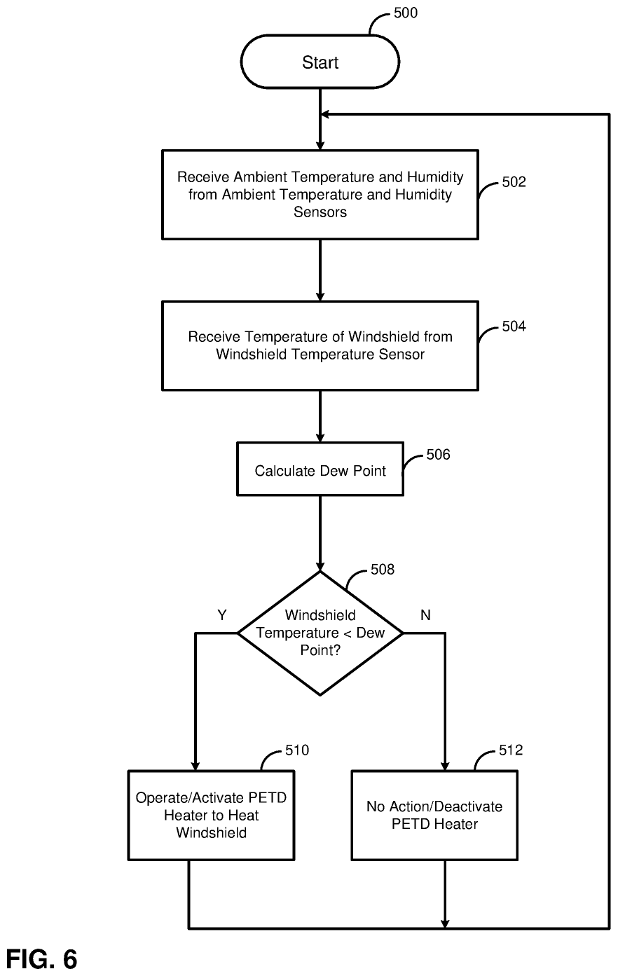

With reference to FIG. 6, a control algorithm for a PETD heater system 10 is shown. The control algorithm can be executed and performed by the PETD control module 18 or any other suitable computing device configured to perform the illustrated functionality and configured to communicate with the noted sensors and components. The control algorithm starts at 500. At 502, the PETD control module 18 receives the ambient temperature and humidity data from the temperature sensors 42, 46 and humidity data from the humidity sensor 44. Exterior humidity and/or dew point data may also be received by way of the receiver 48 from an external source that transmits weather reports. At 504, the PETD control module 18 receives the temperature of the windshield from the windshield temperature sensor 44. At 506, the PETD control module 18 calculates the current dew point or retrieves the dew point from the weather report. At 508, the PETD control module 18 compares the temperature of the windshield 12 with the current dew point. At 508, when the temperature of the windshield 12 is less than the dew point (or less than a predetermined range of the dew point, such as a range of +/−2° C. of the dew point, for example), the PETD control module 18 proceeds to 510 and operates/activates the PETD heater by applying a voltage to the transparent metallic layer 14 to heat the windshield. At 508, when the temperature of the windshield 12 is not less than the dew point (or a range of +/−2° C. of the dew point, for example), the PETD control module 18 then proceeds to 512 and takes no action or deactivates the PETD heater if it was previously activated. After 510 and 512, the PETD control module loops back to 502.

In an embodiment, the PETD heater system 10 can be operated to periodically activate PETD heating of the windshield 12 while the vehicle is parked to heat the windshield 12 and prevent ice and frost from forming on the windshield 12 while the vehicle is parked. For example, the PETD control module 18 can periodically apply voltage to the transparent metallic layer 14 at predetermined time intervals while the vehicle is parked to keep the windshield 12 above a determined or predetermined threshold temperature, such as by using a timer. For example, the PETD heater system 10 can be configured to keep the windshield 12 above freezing temperature so that ice and frost does not form on the windshield 12.

The predetermined time intervals for activating and operating the PETD heater system 10 can be predetermined, such as every minute, every two minutes, every five minutes, or any other suitable period of time, etc. Alternatively, the predetermined time intervals can be calculated and determined based on the sensed parameters about the environment of the vehicle, such as the outdoor ambient temperature as sensed by the ambient temperature sensor 42 and the humidity of the environment of the vehicle as sensed by the humidity sensor 44 or as reported in a weather report received by the receiver 48, and/or the temperature of the windshield 12 as sensed by the windshield temperature sensor 40. The PETD control module 18 can be in communication with the applicable sensors, as necessary, and as shown in FIG. 1, to receive data regarding the various sensed parameters.

Additionally or alternatively, the PETD control module 18 can operate the PETD heater system 10 to heat the windshield 12 based on the sensed parameters, such as the ambient temperature and humidity of the environment and/or the temperature of the windshield. For example, the PETD control module 18 can monitor the temperature of the windshield 12 as sensed by the windshield temperature sensor 40 and can activate the PETD heater system 10 to apply voltage to the transparent metallic layer 14 once the temperature of the windshield 12 falls below a predetermined threshold to keep the temperature of the windshield 12 above the predetermined threshold. For example, the PETD control module 18 can use a proportional-integral-derivative (PID) control algorithm based on the sensed temperature of the windshield 12 and the target temperature threshold for the windshield 12. Other suitable control algorithms can also be used. Additionally or alternatively, a duty cycle D can be used to periodically activate the PETD heater system 10 using pulse-width modulation to activate the PETD heater system 10 for a calculated portion of a period T.

Additionally or alternatively, the PETD control module 18 can receive the ambient outdoor temperature as sensed by the outdoor temperature sensor 42, the humidity sensed by the humidity sensor 44 and/or as set forth in a weather report received by the receiver 48, and the indoor temperature sensed by the indoor temperature senor 46, and can calculate the current dew point of the environment of the vehicle 30. The PETD control module 18 can then periodically operate the PETD heater system 10 to heat and maintain the temperature of the windshield 12 to a temperature above the current dew point (or above a predetermined range of the dew point, such as +/−2° C. of the dew point, for example) to prevent fog and condensation from forming on the windshield. For example, the PETD control module 18 can use a PID control algorithm, or another suitable control algorithm, to determine a duty cycle for applying voltage to the transparent metallic layer 14 to heat the windshield 12.

In one embodiment, the period of control could be relatively longer, such as five minutes. During that time, the PETD heater system 10 could heat the windshield 12 to a temperature that is a few degrees, such as 4 or 5 degrees, above the current dew point and then allow the windshield to cool to a temperature that gets close to the current dew point before activating the heater system again. In another embodiment, the period of control could be relatively shorter, such as one minute. In that case, the PETD heater system 10 could heat the windshield 12 to a temperature that is only one or two degrees above the current dew point to continually maintain a temperature of the windshield 12 at a point that is one or two degrees above the current dew point.

In an embodiment that includes the PETD heater system 10 installed in an electric vehicle or hybrid vehicle, different control strategies could be used depending on whether the vehicle 30 is plugged in and charging and/or depending on whether shore power is available for the PETD heater system 10. For example, in one embodiment the PETD heater system 10 could be configured to heat the windshield 12 of the vehicle 30 to prevent ice, frost, and fog only when the vehicle 30 is parked and plugged in and to prevent the PETD heater system 10 from operating when the vehicle 30 is parked but not plugged in. Additionally or alternatively, the PETD heater system 10 could be configured to heat the windshield 12 using a first control strategy with first control parameters when the vehicle 30 is parked and plugged in and to heat the windshield 12 using a second control strategy with second control parameters when the vehicle 30 is parked and not plugged in. The second control strategy and second control parameters could be configured to utilize less power and energy than the first control strategy and first control parameters. Additionally or alternatively, the PETD heater system 10 can be configured to monitor a remaining battery charge of a battery of the vehicle 30 and can utilize different control strategies based on the remaining charge of the battery of the vehicle 30. For example, when the remaining charge of the battery of the vehicle 30 is less than a predetermined threshold, the PETD heater system 10 can switch to a more energy efficient control strategy and/or can prevent further heating of the windshield 12 of the vehicle 30 using the PETD heater system 10.

Additionally or alternatively, the PETD heater system 10 can be configured to preheat the windshield 12 of the vehicle 30 based on known or determined schedule of a user of the vehicle 30. For example, the PETD heater system 10 can be configured to determine that the user departs for work at a predetermined time every morning, such as 8:00 am. In such case, the PETD heater system 10 can begin to activate and heat the windshield 12 a predetermined amount of time before the user's anticipated departure time. The PETD heater system 10 can also determine that the user plugs the vehicle in when the user arrives at work. In such case, the PETD heater system 10 can monitor the current charge of the battery of the vehicle 30 and operate the PETD heater system 10 anticipating that the battery of the vehicle 30 will be recharged once the user arrives at work. For further example, the PETD heater system 10 can be configured to continually heat the windshield 12 while the vehicle 30 is plugged in and can then switch to a control strategy based on the habits and schedule of the user of the vehicle, i.e., based on departure times and anticipated charging times, when the vehicle 30 is not plugged in.

Additionally or alternatively, the PETD heater system 10 can be configured to only use shore power when the vehicle 30 is plugged in and to not operate off of battery power of the vehicle 30. In other words, the PETD heater system 10 can be configured to operate only on shore power and to not operate with power from the battery of the vehicle 30. In this way, the PETD heater system 10 can be prevented from draining a battery of the vehicle 30.

The PETD heater system 10 can be configured with a proximity sensor to sense and determine whether the vehicle 30 is at a location near an object that is emitting heat, such as a building or tree. The PETD heater system 10 can be configured to account and optimize operation accounting for any heat emitted by objects in the environment of the vehicle 30.

In a vehicle 30 that includes both a PETD heater system 10 and an HVAC system with a defrost function, the PETD heater system 10 can be configured to be operated first and prior to the operation of the defrost function of the HVAC system of the vehicle 30. For example, the PETD heater system 10 can be operated and the defrost function of the HVAC system can be disabled and prohibited from operating while the PETD heater system 10 is operating to defrost, deice, or defog the windshield 12.

Additionally or alternatively, the control algorithm can include additional checks and additional strategies, as discussed above, based on whether the vehicle 30 is connected to shore power, based on the current charge state of a battery of the vehicle, based on a schedule or habits of a user of the vehicle, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A system for electrically heating glass configured for installation on a vehicle, the system comprising:
a transparent metallic layer configured to be mounted to the glass, conduct electrical current, and increase in temperature to heat the glass in response to electrical current running across the transparent metallic layer;
a glass temperature sensor configured to sense a glass temperature of the glass;
a humidity sensor configured to sense humidity of at least one of cabin humidity inside the vehicle and exterior humidity outside of the vehicle;
a cabin temperature sensor configured to sense cabin temperature of the vehicle;
an exterior temperature sensor configured to sense exterior temperature outside of the vehicle; and
a control module configured to:
receive inputs from at least one of the glass temperature sensor, the humidity sensor, the cabin temperature sensor, the exterior temperature sensor, an occupant detection system, and a vehicle speed sensor;
determine a remedial action based on at least one of the received inputs from the at least one of the glass temperature sensor, the humidity sensor, the cabin temperature sensor, the exterior temperature sensor, the occupant detection system, and the vehicle speed sensor; and
control electrical current to the transparent metallic layer based on at least one of the inputs and the remedial action.

2. The system of claim 1, further comprising the glass configured as a windshield.

3. The system of claim 1, further comprising the glass configured as one of a side window of the vehicle, a rear window of the vehicle, and a roof of the vehicle.

4. The system of claim 1, wherein the transparent metallic layer is mounted between a first layer and a second layer of the glass.

5. The system of claim 1, wherein the control module is configured as a pulse-electro thermal deicing (PETD) control module, and configured to control electrical current to the transparent metallic layer to deice the glass.

6. The system of claim 1, further comprising bus bars electrically connected to the transparent metallic layer and the control module, the bus bars configured to distribute electrical current across the transparent metallic layer.

7. The system of claim 1, wherein when performing the remedial action the control module is configured to:
direct electrical current to the transparent metallic layer at a first voltage when the inputs from the occupant detection system and the vehicle speed sensor indicate that the vehicle is unoccupied or the vehicle is stopped; and
direct electrical current to the transparent metallic layer at a second voltage that is lower than the first voltage when the inputs from the occupant detection system and the vehicle speed sensor indicate that the vehicle is occupied and moving.

8. The system of claim 1, wherein when performing the remedial action the control module is configured to:
calculate a dew point based on at least one of the cabin temperature, the exterior temperature, the exterior humidity, and the cabin humidity; and
periodically apply voltage from a power supply to the transparent metallic layer to heat the glass based on the glass temperature and the dew point.

9. The system of claim 1, further comprising a receiver configured to receive a weather report including a dew point.

10. The system of claim 9, wherein the control module is configured to control electrical current to the transparent metallic layer to heat the glass until the glass temperature is greater than a predetermined temperature range including the dew point.

11. A system for electrically heating glass configured for installation on a vehicle, the system comprising:
a transparent metallic layer configured to be mounted adjacent to the glass;
a power supply; and
a control module configured to:
communicate with a glass temperature sensor configured to sense a temperature of the glass;
communicate with at least one of an indoor temperature sensor configured to sense a temperature inside the vehicle, and an outdoor temperature sensor configured to sense a temperature outside the vehicle;
receive the glass temperature from the glass temperature sensor;
receive at least one of the temperature inside the vehicle from the indoor temperature sensor, the temperature outside the vehicle from the outdoor temperature sensor, and a humidity value of humidity inside or outside of the vehicle;
calculate a dew point based on at least one of the temperature inside the vehicle, the temperature outside the vehicle, and the humidity value; and
periodically apply voltage from the power supply to the transparent metallic layer to heat the glass based on the glass temperature and the dew point.

12. The system of claim 11, wherein the glass is configured as one of a windshield, a side window of the vehicle, a rear window of the vehicle, and a roof of the vehicle.

13. The system of claim 11, wherein the control module is configured to control current effective voltage to the transparent metallic layer by pulse-width modulation and duty cycle control.

14. The system of claim 11, wherein the control module is further configured to retrieve the humidity value from a weather report transmitted to the control module.

15. The system of claim 11, wherein the control module is further configured to:
receive inputs from an ice/frost sensor configured to sense a condition of ice and frost present on the glass; and
operate a wiper to wipe the glass when the inputs from the ice/frost sensor indicate that the condition of the ice or frost is suitable for being cleared by the wiper.

16. A system for electrically heating glass configured for installation on a vehicle, the system comprising:
a transparent metallic layer configured to be mounted to the glass, be selectively connected to a battery, conduct electrical current, and increase in temperature to heat the glass in response to electrical current running across the transparent metallic layer;
a vehicle heating system configured to selectively heat the battery and a cabin of the vehicle; and
a control module configured to:
selectively connect the transparent metallic layer to the battery;
during a first time period, activate the vehicle heating system to heat the battery without heating the cabin, and without connecting the transparent metallic layer to the battery;
during a second time period after the first time period, deactivate the heating system and connect the transparent metallic layer to the battery to heat the transparent metallic layer and the glass; and
during a third time period after the second time period, disconnect the transparent metallic layer from the battery, and activate the heating system to heat the cabin without heating the battery.

17. The system of claim 16, wherein the vehicle heating system includes a heat pump system configured to heat at least one of the battery and the cabin.

18. The system of claim 17, further comprising a radiant heater system configured to heat an occupant of the vehicle;
wherein the control module is further configured to activate the radiant heater system during the second time period, and deactivate the radiant heater system during the first time period.

19. The system of claim 18, further comprising a carbon nanotube heater system configured to heat at least a portion of the glass that is not heated by the transparent metallic layer;
wherein the control module is further configured to activate the carbon nanotube heater system during the second time period, and deactivate the carbon nanotube heater system during the first time period.

20. The system of claim 16, wherein the control module is configured as a pulse-electro thermal deicing (PETD) control module, and configured to control electrical current to the transparent metallic layer to control current effective voltage to the transparent metallic layer by pulse-width modulation and duty cycle control.
